(19) United States
(12) Patent Application Publication
(10) Pub. No.: US 2025/0196685 A1
(43) Pub. Date: Jun. 19, 2025

(54) WIRELESS CHARGING METHOD AND APPARATUS

(71) Applicant: EATON INTELLIGENT POWER LIMITED, Dublin 4 (IE)

(72) Inventors: Salma ABDULAZIZ, Dublin (IE); Julia O'CONNELL, Dublin (IE); Colm GALLAGHER, Dublin (IE)

(21) Appl. No.: 18/849,625

(22) PCT Filed: Mar. 23, 2022
(86) PCT No.: PCT/EP2022/057703

§ 371 Date: Sep. 23, 2024

(51) Int. Cl. B60L 53/39; B60L 53/126; H02J 50/80; H02J 50/90

(52) U.S. Cl. CPC B60L 53/39; B60L 53/126; H02J 50/80; H02J 50/90

(57) ABSTRACT

A method of charging a device wirelessly with a wireless charger begins after the device is located adjacent to the wireless charger. The wireless charger receives or determines a position of an induction coil of the device. The wireless charger then determines a position which can be reached by a charging coil of the wireless charger that will provide most efficient power transfer to the induction coil of the device. The charging coil of the wireless charger is then moved to this reachable position, and the device is charged wirelessly using the charging coil. A suitable wireless charger and an appropriately configured chargeable device are also described.

### CROSS-REFERENCE TO RELATED APPLICATIONS

This application is a national phase filing under 35 C.F.R. § 371 of and claims priority to PCT Patent Application No. PCT/EP2022/057703, filed on Mar. 23, 2022, the contents of which are hereby incorporated in its entirety by reference.

### TECHNICAL FIELD

The disclosure relates to a wireless charging method and apparatus. Particular embodiments of the disclosure relate to the charging of electric vehicles, though embodiments of the disclosure are not limited to this application.

### BACKGROUND

Wireless charging is a growing trend among a range of personal electronic devices such as mobile phones, smart watches and tablets. Wireless charging uses the inductive coupling of two copper coils to transfer energy from an energy source to a receiver of the device to be charged. The coil within the energy source is typically contained within a pad where the receiver device is placed. The coil within the receiver device is embedded into its structure and is used to charge the battery of that device. This development in charging technology is mainly due to its convenience for the user. It reduces the amount of interaction between the user and device, minimizing the rate of error and it also reduces wear and tear of plugs and sockets. The main drawback of wireless charging is the reduced efficiency. There can be significant power losses if the coils are not optimally placed. Normally, an efficiency rate of 85%-90% is achieved if the coils are placed in a near perfect position for smaller electronic devices.

Wireless charging can be used in a wide range of applications, including but not limited to, electric vehicles, mobile phones, drones and even household appliances such as Roombas. However, the use case of electric vehicles poses a particular challenge for effective wireless charging.

The current charging infrastructure for electric vehicles requires significant user intervention. The process includes removing the charging cable from inside the vehicle where it is stored when not in use, opening the charge port on the vehicle, plugging in the cable, plugging in the other port of the cable into the charging point and finally, activating the charging point. This is a lengthy interaction for a very simple process. This user intervention could be entirely circumvented by an appropriate wireless charging method.

The practical challenge for using wireless charging for electric vehicles is provided by the larger surface area in which the coils could be contained within the vehicle and the significant physical distance normally present between the receiver coil in the vehicle and the charging pad. Both of these greatly reduce the efficiency of power transfer, and it would be desirable to achieve a method of wireless charging, particularly in this context, that provided effective wireless charging without significant user intervention.

### SUMMARY OF DISCLOSURE

In a first aspect, the disclosure provides a method of charging a device wirelessly with a wireless charger, the method comprising on the device being located adjacent to the wireless charger, the wireless charger: receiving or determining a position of an induction coil of the device; determining a reachable position of a charging coil of the wireless charger for most efficient power transfer to the induction coil of the device; moving at least the charging coil of the wireless charger to the reachable position; and charging the device wirelessly using the charging coil.

In embodiments, the wireless charger is notified of the position of the induction coil of the device relative to the device, and it is notified of an orientation of the induction coil of the device in addition to the position. Using this approach, the charging system receives the orientation of the object to be charged and the coil position within that object from the object itself. It then calculates its own position in relation to the coil in the object and moves to the position beneath the object that would produce the greatest efficiency of power transfer. This is a particularly effective approach where the object is an electric vehicle.

The wireless charger may also determine a position and an orientation of the charging coil of the wireless charger before moving the charging coil of the wireless charger to the reachable position. Determining an orientation of the charging coil may comprise obtaining a measurement from a wireless charger gyroscope associated with the charging coil.

In one type of embodiment, the charging coil may be located on a charging pad within the wireless charger, and the reachable position is then determined by positions reachable by the charging pad within the wireless charger. In another type of embodiment, the wireless charger is itself moveable, and the reachable position is then determined by positions reachable by the charging pad relative to the device.

When the charging coil is in the reachable position, the wireless charger may determine whether a power factor for charging exceeds a threshold value indicating that power transfer is sufficiently effective for charging to take place. This may be done by the charging coil receiving a predetermined power transfer signal from the induction coil of the device for the wireless charger to determine whether the power factor exceeds the threshold value. In such a case, if the power factor does not exceed the threshold value, the wireless charger may perform a local optimisation to determine whether there is a further reachable position local to the reachable position at which the power factor would exceed the threshold value, and if so, the wireless charger may then move the charging coil to the further reachable position. This approach may for example be followed if the power factor is slightly below the threshold value (for example, exceeding a lower threshold value) but if the power factor is significantly lower, then the process may simply be restarted. If local optimisation is used, the acceptability threshold for restarting the process may be the lower threshold value—if it is not, it may simply be the threshold value.

As noted above, this method is particularly suitable for use when the device is an electric vehicle.

In a second aspect, the disclosure provides a wireless charging system, comprising a wireless charging system controller, a charging pad comprising a charging coil, and a movement system for moving at least the charging coil, wherein the wireless charging system controller is adapted to receive or determine a position of an induction coil of a device to be charged, to determine a reachable position for a charging coil of the wireless charger for most efficient power transfer to the induction coil of the device, to control the movement system for moving at least the charging coil of the wireless charger to the reachable position, and to charge the device wirelessly using the charging coil.

The wireless charging system controller may be adapted to receive notification of the position and/or the orientation of the induction coil of the device to be charged. The wireless charging system controller may be further adapted to determine a position and an orientation of the charging coil of the wireless charger before moving the charging coil of the wireless charger to the reachable position. In such a case, the wireless charging system may further comprise a wireless charger gyroscope associated with the charging coil.

In one type of embodiment, the charging coil is located on a charging pad within the wireless charger, and the reachable position is determined by positions reachable by the charging pad within the wireless charger using the movement system. In another type of embodiment, the wireless charger is itself moveable, and the reachable position is determined by positions reachable by the charging pad relative to the vehicle using the movement system.

The movement system may comprise one or more actuators, and at least one of the one or more actuators may be a solenoid actuator.

In embodiments, when the charging coil is in the reachable position, the wireless charging system controller may be adapted to determine whether a power factor for charging exceeds a threshold value indicating that power transfer is sufficiently effective for charging to take place.

The wireless charging system may be an electric vehicle wireless charging system.

In a third aspect, the disclosure provides an electrical device adapted for wireless charging, the electrical device comprising a device controller adapted to control a device charging system, wherein the device charging system comprises an induction coil for wireless charging, wherein the device controller is adapted to communicate a position of the induction coil in the device to a wireless charging system.

The device controller may be adapted to notify the position of the induction coil in the device relative to the device to the wireless charging system. The electrical device may further comprise a gyroscope associated with the induction coil, wherein the device controller is adapted to read the gyroscope and to notify an orientation of the induction coil to the wireless charging system.

On notification that a charging coil of the wireless charging system is in an intended charging position, the device controller may be adapted to send a predetermined power transfer signal through the induction coil to enable the wireless charging system to determine whether power transfer is sufficiently effective for charging to take place.

The electrical device may be an electric vehicle.

### BRIEF DESCRIPTION OF FIGURES

Embodiments of the disclosure will now be described, by way of example, with reference to the following figures, in which:

FIG. 1 shows the fundamental elements of a wireless charging system;

FIG. 2 describes a charging method according to a general embodiment of the disclosure;

FIGS. 3 and 4 show respectively a side view and a ground view of a first embodiment of the disclosure in which a charger is moved to a determined best charging position;

FIGS. 5 and 6 show respectively a side view and a ground view of a second embodiment of the disclosure in which a charging coil within a charger is moved to a determined best charging position;

FIG. 7 shows a system architecture for a charging ecosystem according to an embodiment of the disclosure; and

FIGS. 8A and 8B set out in detail steps in a method according to an embodiment of the disclosure.

### DETAILED DESCRIPTION

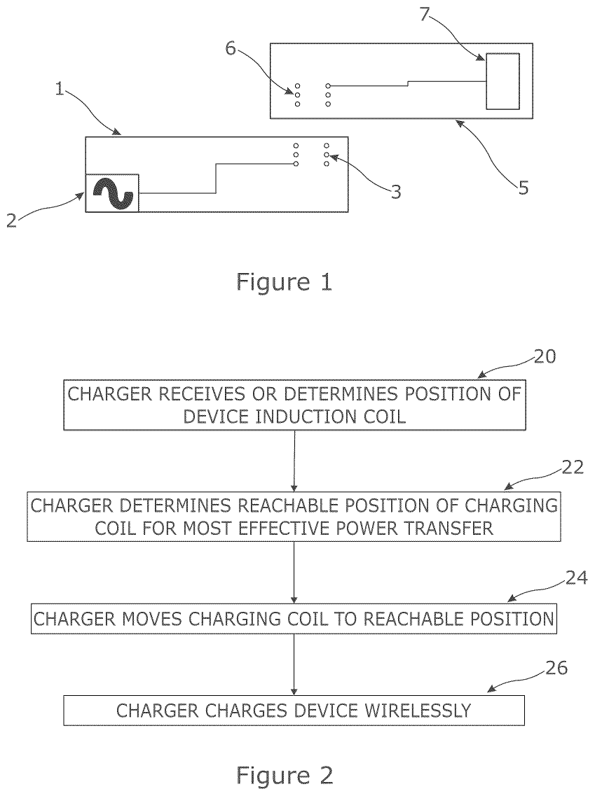

FIG. 1 illustrates the fundamental elements of a wireless charging system. A charger 1 contains an electrical power source 2 and a charging coil 3. A device to be charged 5 contains an induction coil 6 and a battery 7. Wireless charging transfers energy through inductive coupling, and is also known as inductive charging as a result. The electrical power source 2 provides alternating current, which passes through the charging coil 3. The moving electric charge creates a magnetic field, which fluctuates in response to the fluctuation in current amplitude. This changing magnetic field creates an alternating electric current in the induction coil of the device, which in turn passes through a rectifier 8 to convert it to direct current. Finally, this direct current charges the battery 7. There are various known approaches to improve aspects of this process—for example, charging range can be increased by use of tuned LC circuits (resonant inductive coupling), but the coupling of the field produced at the charging coil 3 into the induction coil 6 is fundamental to the process.

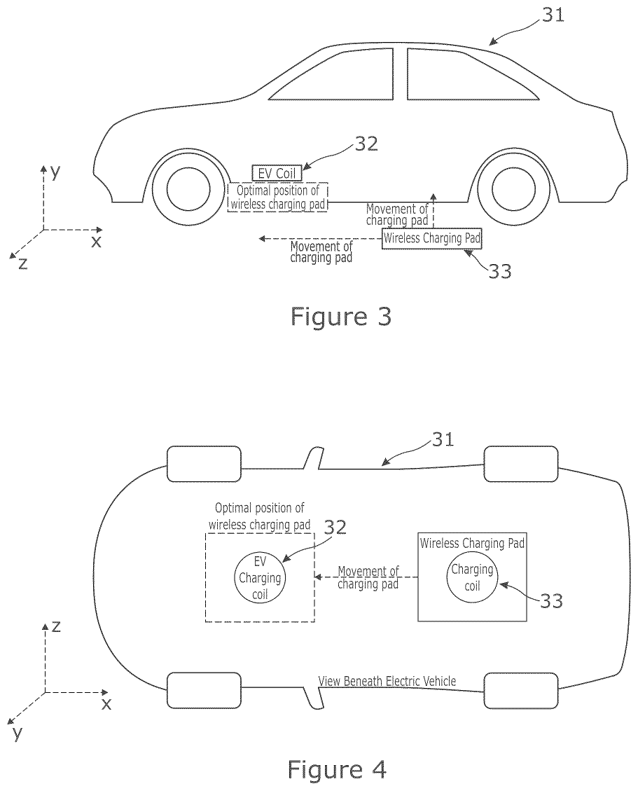

FIG. 2 illustrates a charging method according to a general embodiment of the disclosure. It is assumed that first of all, the device to be charged is placed in proximity to the wireless charger—after this, the wireless charger takes the following steps. First of all, the wireless charger receives or determines 20 the position of an induction coil within the device to be charged. As will be described below, this may be as a result of the device signalling to the charger the position (and possibly even orientation) of the induction coil within the device, but may be the result of other detection strategies (such as the charger recognising the position of the induction coil from a visible marking on the device). After this, the charger determines 22 a reachable position of the charging coil of the charger for most efficient power transfer to the induction coil of the device. This position needs to be reachable—in that the movement mechanism associated with the charger is capable of moving the charging coil to that position—rather than ideal. The charger then moves 24 at least the charging coil to the reachable position, and charges 26 the device wirelessly (possibly after a further step to check that the reachable position does achieve optimal power transfer, which may also include local optimisation of the charging coil position).

This approach is particularly appropriate for use with an electric vehicle, where positioning the vehicle with respect to a charging coil is not straightforward and is currently, as noted above, a process involving considerable manual assistance. With this approach, the positioning of an electric vehicle relative to a charger will not require manual intervention after simply moving the electric vehicle to a charging bay.

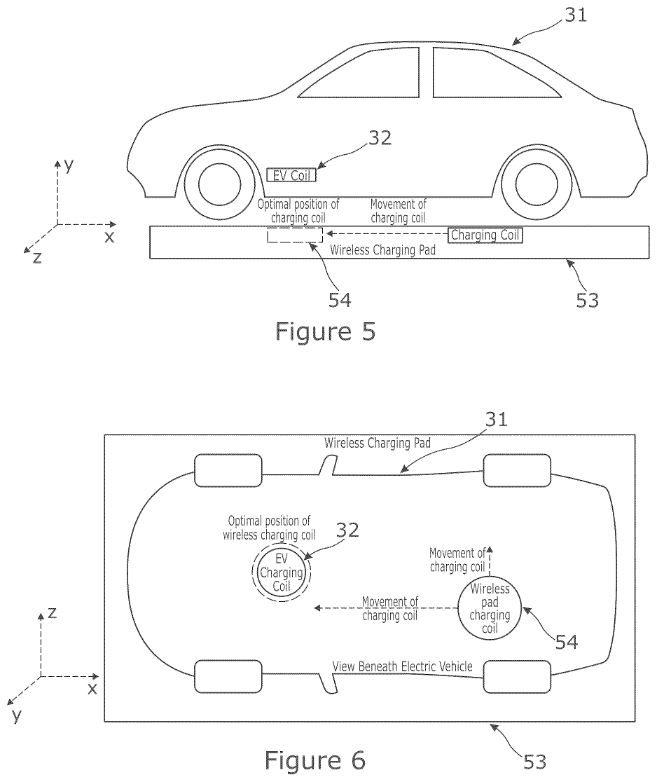

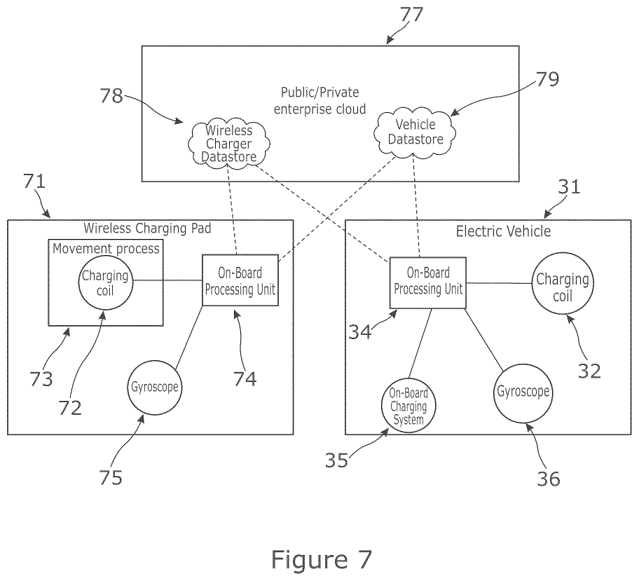

Two different embodiments of a wireless charger adapted to implement this strategy are shown in FIGS. 3 and 4 (first embodiment) and FIGS. 5 and 6 (second embodiment). In the FIG. 3 embodiment, the wireless charger is in the form of a pad that can both translate and elevate in position. As shown in FIG. 3, the optimal position of the wireless charging pad 33 with respect to the EV coil 32 in the EV (electric vehicle) 31 is located directly underneath the EV coil 32 and with an elevation that brings the charging pad directly adjacent to the bottom of the car—(in FIG. 3, this is shown to be a position more elevated than the bottom of the side of the car). In this case, this is the position that is both reachable by the wireless charging pad 33 and capable of the most effective power transfer between the charging coil of the wireless charging pad 33 and the EV coil 32—as can be seen from FIGS. 3 and 4, this here involves a translation along the length of the EV 31 and an elevation to the optimal charging position.

FIGS. 5 and 6 show a second embodiment in which the charging coil 54 is located within a much more extensive charging pad 53 on which the EV 31 parks. It is not possible for the charging coil 54 to be moved to a position that is outside the charging pad 53 in this case, so the reachable position of the charging coil 54 providing the greatest power transfer is within the charging pad 53 but disposed directly below the EV coil 32 (and in this case, separated from it by an air gap).

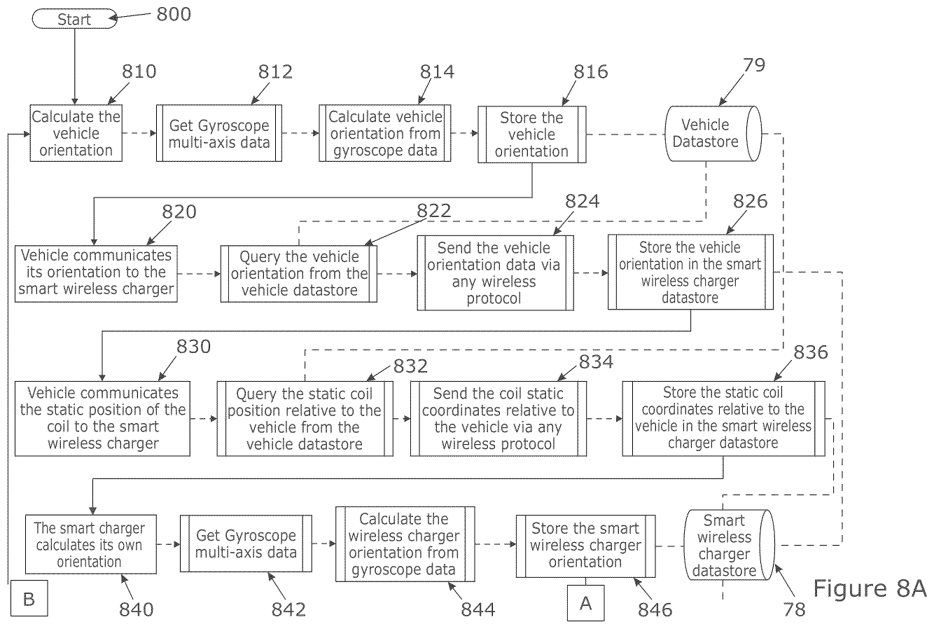

A system architecture supporting the charging arrangement is shown in FIG. 7. The wireless charging pad 71 comprises a charging coil 72 which has an associated movement process 73. The charging pad 71 operates under the control of an on-board processing unit 74, which controls the movement process 73 and receives information from sensors such as a gyroscope 75, which can be used to determine position and orientation of the charging pad 71. The vehicle 31 has an induction coil 32—the vehicle 31 operates under control of an on-board processing unit 34 (which may be one of the control systems conventionally present in a vehicle) and interacts with the on-board charging system controller 35 (which manages all charging, whether inductive or by direct connection). The on-board processing unit 34 in the vehicle also receives information from sensors such as a gyroscope 36, which can be used to determine position and orientation of the induction coil 32. The on-board processing unit 74 of the charging pad 71 and the on-board processing until 34 of the vehicle are here both capable of interacting with cloud-based systems 77, which may include datastores such as wireless charger datastore 78 and vehicle datastore 79 which can be used to provide vehicle information to the charging pad 71 and charger information to the vehicle 31.

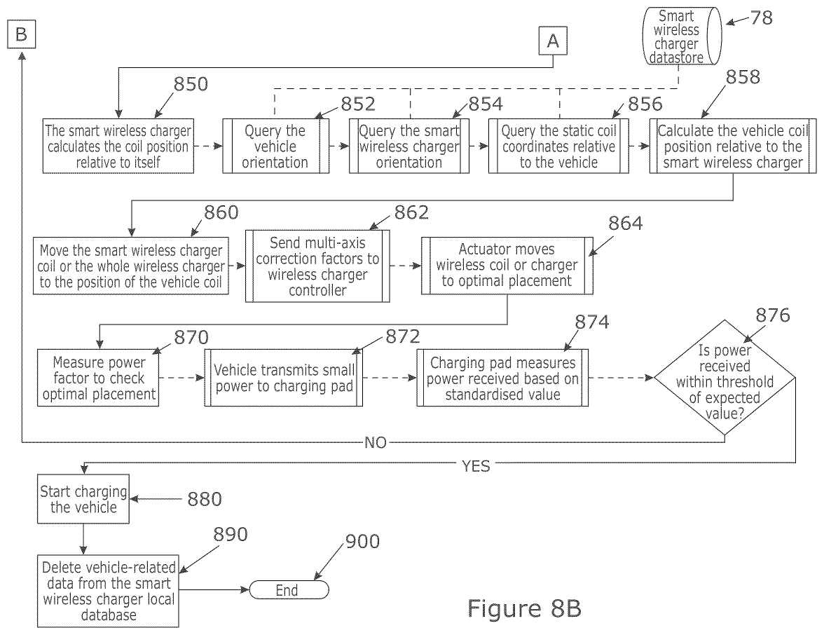

A method according to an embodiment of the disclosure will now be discussed in detail with reference to FIGS. 8A and 8B. From initiation 800 of the process—for example, by an indication from the on-board processing unit 34 of the vehicle to the on-board charging system 35 that optimised wireless charging was to take place—the first step is the calculation 810 of the vehicle orientation, that is, the orientation of the vehicle in space after parking. This has the following sub-steps. Sensor data is obtained 812 from the gyroscope 36 (or any other sensor, or sensor combination, used for this purpose) in the vehicle to obtain multi-axis data indicating angular orientation of the sensor. The orientation of the vehicle can then be calculated 814, as the position and orientation of the sensor in the vehicle is known. The vehicle orientation is then stored 816—this may be in the vehicle datastore 79 as previously described.

The next step is for the vehicle to communicate 820 its own orientation to the wireless charger. It can query 822 its own database for orientation information and send 824 it (typically by an appropriate wireless protocol, such as WiFi) to the charger. The wireless charger will then store 826 this information in the wireless charger datastore 78.

The vehicle will now also communicate 830 the static position of the induction coil 32 (relative to the vehicle) to the wireless charger. This static position is also stored in the vehicle datastore 79, and the first sub-step of this process is for the vehicle to query 832 the local datastore for the coil static position and to communicate 834 this information to the wireless charger as for the orientation information. This information will then also be stored 836 by the wireless charger in the wireless charger datastore 78.

The next step is for the wireless charger to calculate 840 its own orientation. It does this by obtaining 842 multi-axis data from its own gyroscope 75, calculating 844 its orientation (or specifically the orientation of the charging pad) from that gyroscope data (if the charging pad is moveable within the charger, the gyroscope 75 will be located with the charging pad), and storing the calculated orientation in the wireless charger datastore 78.

The next step (shown on FIG. 8B, following letter A) is for the wireless charger to calculate the position of the vehicle induction coil 32 relative to itself (more specifically, relative to the charging coil 72 of the wireless charger). This is done by querying the stored data—in this case, querying 852 the vehicle position and orientation, querying 854 the charging pad orientation, and querying 856 the coordinates of the vehicle static coil position—and using this stored data to calculate 858 a position of the charging coil 72 which is reachable by use of the movement process 73, and of the positions reachable by the movement process 73, provides the best calculated power transfer between the charging coil 72 and the static coil 32. This is a straightforward calculation based on the relative position of the two coils that provides the best coupling of magnetic field between them.

After this, the charging pad is moved 860—either by moving the whole charger in the FIG. 3 case or by moving the charging pad within the charger in the FIG. 5 case—to the calculated position. This is done by determining 862 multi-axis correction factors needed for the charging pad—the movement process 73 will achieve this using appropriate actuators (in the FIG. 5 case, this simply involves movement in two dimensions within the charger plus possible rotation of the coil into an appropriate orientation—in the FIG. 3 case, this may also involve elevation of the charging pad into an appropriate position relative to the vehicle). Solenoid actuators would be an appropriate choice here, as these can be used for both linear and rotational movement and are precise and energy efficient—electric actuators (particularly linear and rotary actuators) are another possible choice. The movement process 73 then moves the charging pad to the appropriate position, using an appropriate number and order of steps (for example, the charging pad may be first moved to the appropriate x/y ground coordinates, rotated if necessary, and then elevated if this is a possible option).

The next step is to determine 870 whether this position is indeed satisfactory—local factors or inaccuracy in stored data or the calculation process may mean that the calculated position is not optimal. In such cases, power factor can be measured to determine whether the placement is effective. This can be done by the vehicle transmitting 872 a small amount of power to the charging pad and the charging pad measuring 874 the received power falls and determining 876 whether it lies within an appropriate threshold. This may require a notification to the vehicle that the charging pad is in the reachable position. If it does lie within this threshold, charging 880 of the vehicle can start, and if not (following line B), the process may need to restart (for example, by re-parking the vehicle and restarting the process).

Other approaches to optimisation may be taken. For example, if it is found that the power factor is inadequate, but is close to being adequate, then the movement process can be used to sample power factor by small variations in the position and orientation of the charging pad—the wireless charger can then carry out a limited optimisation to determine if there is an adequate power factor available by making an appropriate minor variation, in which case the process can proceed to charging 880 of the vehicle. However, if the power factor is found to be completely inadequate, this suggests a calculation or process error, in which case the process should be restarted. It may even be recommended that the vehicle be repositioned relative to the wireless charger.

At the end of the charging process (which will end when the vehicle is charged or the charging process is stopped manually), for data privacy reasons it is desirable for all vehicle related data to be deleted 890 from the wireless charger datastore 78. This ends 900 the charging process.

The skilled person will appreciate that many further embodiments are possible within the spirit and scope of the disclosure set out here. While the embodiment described above relates to electric vehicle charging, embodiments of the presently disclosed subject matter may be applied to other contexts, such as wireless charging of industrial or household apparatus (such as vacuum cleaners) or of personal appliances and devices (such as mobile telephones, smart watches and tablet computers).

1. A method of charging a device wirelessly with a wireless charger, the method comprising on the device being located adjacent to the wireless charger, the wireless charger:
receiving or determining a position of an induction coil of the device;
determining a reachable position of a charging coil of the wireless charger for most efficient power transfer to the induction coil of the device;
moving at least the charging coil of the wireless charger to the reachable position; and
charging the device wirelessly using the charging coil.

2. The method of claim 1, wherein the wireless charger is notified of the position of the induction coil of the device relative to the device.

3. The method of claim 2, wherein the wireless charger is notified of an orientation of the induction coil of the device in addition to the position.

4. The method of claim 1, further comprising the wireless charger determining a position and an orientation of the charging coil of the wireless charger before moving the charging coil of the wireless charger to the reachable position.

5. (canceled)

6. The method of claim 1, wherein the charging coil is located on a charging pad within the wireless charger, and the reachable position is determined by positions reachable by the charging pad within the wireless charger.

7. The method of claim 1, wherein the wireless charger is itself moveable, and the reachable position is determined by positions reachable by the charging pad relative to the device.

8. The method of claim 1, wherein when the charging coil is in the reachable position, the wireless charger determines whether a power factor for charging exceeds a threshold value indicating that power transfer is sufficiently effective for charging to take place.

9. (canceled)

10. The method of claim 8, wherein if the power factor does not exceed the threshold value, the wireless charger performs a local optimisation to determine whether there is a further reachable position local to the reachable position at which the power factor would exceed the threshold value, and if so, the wireless charger moves the charging coil to the further reachable position.

11. The method of claim 8, wherein if the power factor does not exceed an acceptability threshold value, the charging process is restarted.

12. (canceled)

13. A wireless charging system, comprising a wireless charging system controller, a charging pad comprising a charging coil, and a movement system for moving at least the charging coil, wherein the wireless charging system controller is adapted to receive or determine a position of an induction coil of a device to be charged, to determine a reachable position for a charging coil of the wireless charger for most efficient power transfer to the induction coil of the device, to control the movement system for moving at least the charging coil of the wireless charger to the reachable position, and to charge the device wirelessly using the charging coil.

14. The wireless charging system of claim 13, wherein the wireless charging system controller is adapted to receive notification of the position and/or the orientation of the induction coil of the device to be charged.

15. The wireless charging system of claim 13, wherein the wireless charging system controller is further adapted to determine a position and an orientation of the charging coil of the wireless charger before moving the charging coil of the wireless charger to the reachable position.

16. (canceled)

17. The wireless charging system of claim 16, wherein, the charging coil is located on a charging pad within the wireless charger, and wherein the reachable position is determined by positions reachable by the charging pad within the wireless charger using the movement system;
the wireless charger is itself moveable, and the reachable position is determined by positions reachable by the charging pad relative to the device using the movement system.

18. (canceled)

19. (canceled)

20. (canceled)

21. The wireless charging system of claim 13, wherein when the charging coil is in the reachable position, the wireless charging system controller is adapted to determine whether a power factor for charging exceeds a threshold value indicating that power transfer is sufficiently effective for charging to take place.

22. The wireless charging system of claim 13, wherein the wireless charging system is an electric vehicle wireless charging system.

23. An electrical device adapted for wireless charging, the electrical device comprising a device controller adapted to control a device charging system, wherein the device charging system comprises an induction coil for wireless charging, wherein the device controller is adapted to communicate a position of the induction coil in the device to a wireless charging system.

24. The electrical device of claim 23, wherein the device controller is adapted to notify the position of the induction coil in the device relative to the device to the wireless charging system.

25. The electrical device of claim 23, wherein the electrical device further comprises a gyroscope associated with the induction coil, and wherein the device controller is adapted to read the gyroscope and to notify an orientation of the induction coil to the wireless charging system.

26. The electrical device of claim 23, wherein on notification that a charging coil of the wireless charging system is in an intended charging position, the device controller is adapted to send a predetermined power transfer signal through the induction coil to enable the wireless charging system to determine whether power transfer is sufficiently effective for charging to take place.

27. The electrical device of claim 23, wherein the electrical device is an electric vehicle.
